(19) United States
(12) Patent Application Publication
(10) Pub. No.: US 2008/0100717 A1
(43) Pub. Date: May 1, 2008

(54) Method and apparatus for taking a moving picture

(75) Inventor: O-hyun Kwon, Seongnam-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/784,486

(22) Filed: Apr. 6, 2007

(30) Foreign Application Priority Data
Oct. 27, 2006 (KR) 10-2006-0105297

(51) Int. Cl. H04N 5/21

(52) U.S. Cl. 348/208.99

(57) ABSTRACT

A method and apparatus for taking a moving picture and stabilizing the image of the moving picture to reduce the effect caused by shaking of the apparatus. The method and apparatus perform the operations of extracting an edge image of a k^{th} image that is input into the apparatus, extracting an edge image of a k+1^{st} image that is input into the apparatus, calculating a difference in the position of the edge image of the k^{th} image and the position of the edge image of the k+1^{st} image, and stabilizing an image by moving the k^{th} image and/or the k+1^{st} image in accordance with the difference between the positions.

### BACKGROUND OF THE INVENTION

This application claims the priority of Korean Patent Application No. 10-2006-0105297, filed on Oct. 27, 2006, in the Korean Intellectual Property Office, the disclosure of which is incorporated herein in its entirety by reference.

### FIELD OF THE INVENTION

The present invention relates to a method and apparatus for taking a moving picture. More particularly, the present invention relates to a method and apparatus for taking a moving picture and stabilizing an image of the moving picture to reduce the effect caused by shaking of the apparatus.

### DESCRIPTION OF THE RELATED ART

Apparatuses for taking moving pictures are used to take a variety of moving subjects. Attempts to improve these apparatuses are being made as the demand for such portable apparatuses increases. In particular, since a user typically photographs subjects by holding a portable apparatus for taking the moving picture in his or her hands, attempts are being made to stabilize the image of the moving picture to reduce the negative effect caused due to shaking of the apparatus.

FIGS. 1A and 1B are schematic diagrams showing an example of an image tremble occurring when a conventional apparatus for taking a moving picture is used to photograph a subject and movement occurs while photographing. Referring to FIGS. 1A and 1B, even if a subject is photographed when the position of the subject does not actually move, the position of the subject moves in an image since the conventional is shaking in the person's hands. Since the conventional apparatus in this example is shaking up and down, the position of the subject moves up and down in the photographed image. Therefore, when the captured moving picture of the subject is reproduced, the position of the subject in the moving picture image keeps moving, resulting in a subject misplacement and shaking of the image. Thus, a person viewing the image can become dizzy or nauseous.

In order to address these problems, image stabilization technology has been developed. The image stabilization technology computes the relationship (the distance and direction) between the position of a prominent point of a captured k^{th} image (a k^{th} frame image) and the position of a k+1^{st} image of the prominent point (a k+1^{st} frame image), and moves the k+1^{st} image in parallel in an opposite direction according to the relationship. Therefore, the position of the prominent point of the k^{th} image and the position of the prominent point of the moved k+1^{st} image are made identical to each other so that all subjects in the k^{th} image and the moved k+1^{st} image have the same positions. Therefore, even if the conventional apparatus is shaking, when the captured moving picture is reproduced, the position of the subject remains unchanged in the image.

However, the conventional image stabilizing technology cannot stabilize the image when the subject and its background are very simple, or the image is very complicated, and thus the image has no prominent point. Also, image information includes much noise when a subject is photographed at night or indoors. The conventional image stabilizing technology therefore cannot properly stabilize the image since it does not exactly catch a prominent point in the image due to the noise.

### SUMMARY OF THE INVENTION

An embodiment of the present invention provides a method and apparatus for taking a moving picture that perform operations to stabilize an image due to shaking of the apparatus.

According to an aspect of the present invention, the method and apparatus perform operations for extracting an edge image of a k^{th} image that is input into the apparatus, extracting an edge image of a k+1^{st} image that is input into the apparatus, calculating a difference in the position of the edge image of the k^{th} image and the position of the edge image of the k+1^{st} image, and stabilizing an image by moving the k^{th} image and/or the k+1^{st} image according to the difference in the positions.

The operation of extracting the edge image of the k^{th} image includes obtaining an image by moving the k^{th} image by a predetermined distance, and calculating a difference in each pixel between the k^{th} image and the image obtained when the k^{th} image is moved. The operation of extracting the edge image of the k+1^{st} image includes obtaining an image by moving the k+1^{st} image by a predetermined distance, and calculating a difference in each pixel between the k+1^{st} image and the image obtained when the k+1^{st} image is moved.

The operations of obtaining the image by moving the k^{th} image by the predetermined distance and obtaining of the image by moving the k+1^{st} image by the predetermined distance include moving the k^{th} image and the k+1^{st} image in the same direction.

The operation of obtaining the image by moving the k^{th} image by the predetermined distance includes moving the k^{th} image by the predetermined distance up or down, and the operation of obtaining the image by moving the k+1^{st} image by the predetermined distance includes moving the k+1^{st} image by the predetermined distance up or down.

The operation of obtaining the image by moving the k^{th} image by the predetermined distance can also include moving the k^{th} image by the predetermined distance in a diagonal direction, and the operation of obtaining the image by moving the k+1^{st} image by the predetermined distance can also include moving the k+1^{st} image by the predetermined distance in the diagonal direction.

The operation of obtaining the image by moving the k^{th} image by the predetermined distance can further include moving the k^{th} image by the predetermined distance left or right, and the of obtaining the image by moving the k+1^{st} image by the predetermined distance can further include moving the k+1^{st} image by the predetermined distance left or right.

When extracting of the edge image of the k^{th} image, if the difference of each pixel is smaller than a predetermined value, pixels with a value of 0 are provided, and, if the difference of each pixel is greater than the predetermined value, pixels with a value of 1 are provided. Accordingly, when extracting the edge image of the k+1^{st} image, if the difference of each pixel is smaller than the predetermined value, pixels with the value of 0 are provided, and if the difference of each pixel is greater than the predetermined value, pixels with the value of 1 are provided.

The operation of extracting the edge image of the k^{th} image that is input into the apparatus for taking the moving picture can further include converting the k^{th} image into a black image and extracting an edge image of the converted k^{th} image, and the operation of extracting the edge image of the k+1^{st} image that is input into the apparatus for taking the moving picture can include converting the k+1^{st} image into a black image and extracting an edge image of the converted k+1^{st} image.

The operation of stabilizing the image can include moving the unconverted k^{th} image and/or the unconverted k+1^{st} image in accordance with the difference in the positions of the edge image of the k^{th} image and the edge image of the k+1^{st} image. The operation of stabilizing the image can also include moving the k+1^{th} image in an opposite direction by an amount equal to the difference in the positions of the edge image of the k^{th} image and the edge image of the k+1^{st} image, and making the edge image of the k^{th} image correspond to the edge image of the moved k+1^{th} image.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are schematic diagrams showing an example of an image tremble occurring when a conventional apparatus for taking a moving picture is used to photograph a moving subject;

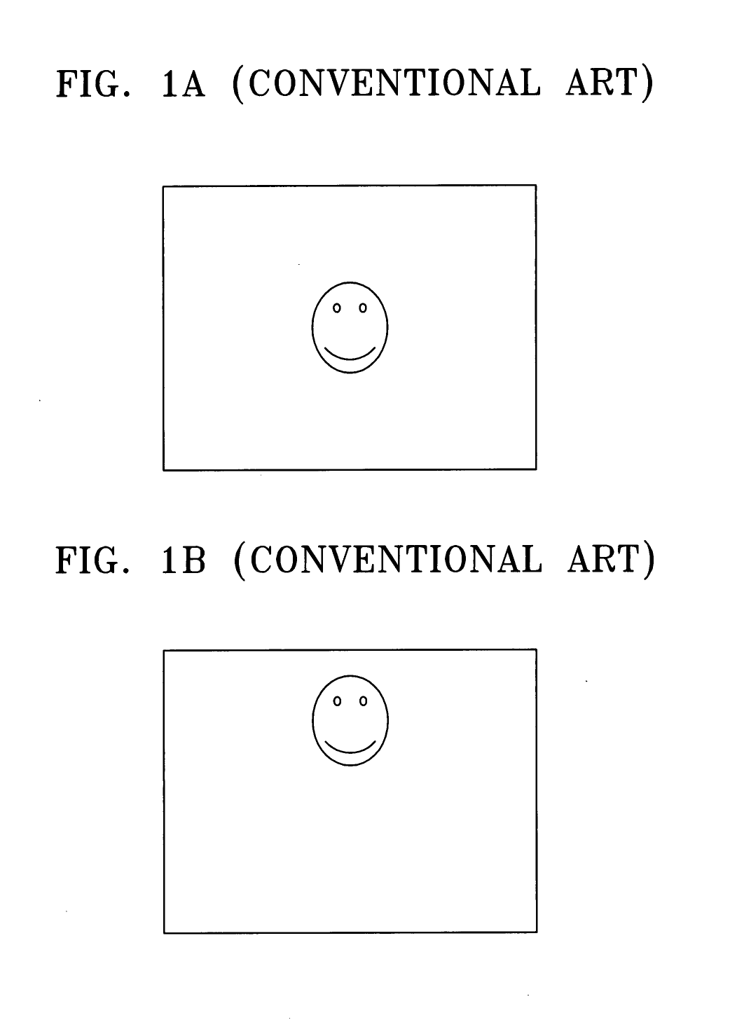

FIGS. 2A through 2C are conceptual diagrams illustrating an example of a process for extracting an edge image using a method of controlling an apparatus for taking a moving picture according to an embodiment of the present invention;

FIGS. 3A and 3B are diagrams illustrating examples of an image before an edge image is extracted from the image, and the edge image extracted from the image, respectively, using the method of controlling an apparatus for taking a moving picture according to an embodiment of the present invention;

FIGS. 4A through 4D are schematic conceptual diagrams illustrating an example of a process of stabilizing an image using an edge image using a method of controlling the apparatus for taking a moving picture according to an embodiment of the present invention;

FIG. 5A is a diagram of an example of an image before an edge image is extracted from the image;

FIG. 5B is a diagram of an example of an image obtained by adding noise to the image illustrated in FIG. 5A;

FIG. 5C is a diagram of an example of an edge image extracted from the image illustrated in FIG. 5B using a method of controlling an apparatus for taking the moving picture according to an embodiment of the present invention; and

FIG. 6 is a block diagram illustrating an apparatus for taking a moving picture according to an embodiment of the present invention;

### DETAILED DESCRIPTION OF THE EMBODIMENTS

Embodiments of the present invention will now be described more fully with reference to the accompanying drawings.

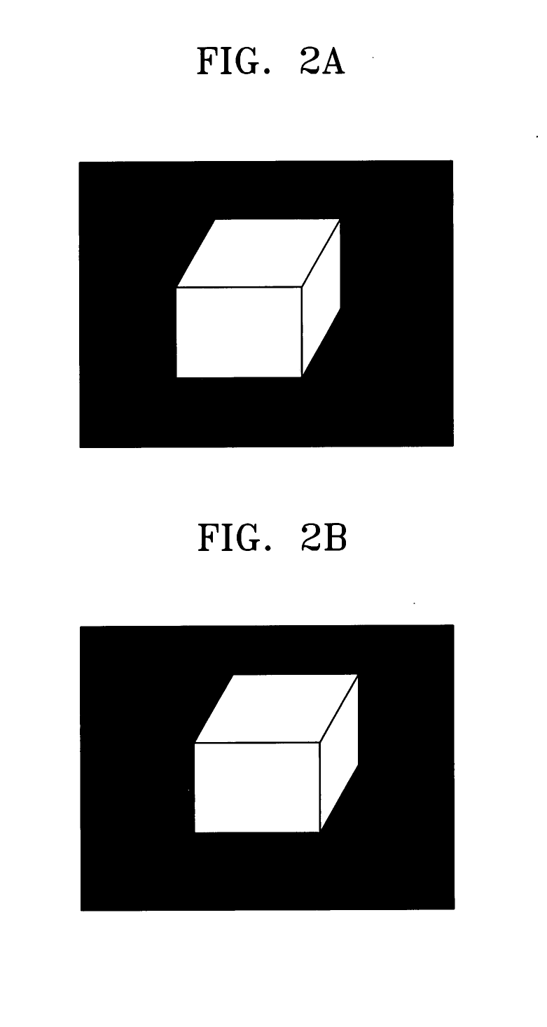

As explained below, an image stabilization technique for use in an apparatus for taking a moving picture according to an embodiment of the present invention can exactly stabilize an image using an edge image. In order to use the edge image, the edge image of each image (each frame image) input into the apparatus for taking the moving picture is extracted. FIGS. 2A through 2C are conceptual diagrams illustrating an example of a process for extracting an edge image using a method of controlling an apparatus for taking a moving picture according to an embodiment of the present invention. For descriptive convenience, a subject is a simple cube, and brightness information of the subject is 0 and 1, i.e., black and white.

Referring to FIG. 2A, an original image captured by the apparatus is an image (a frame image) of a moving picture of a white cube in a black background. In order to extract an edge image, the image is moved in a parallel direction as illustrated in FIG. 2B. In particular, in this example, the image is moved in a parallel upward right direction.

Information on the difference in each pixel between the image illustrated in FIG. 2A and the moved image illustrated in FIG. 2B is obtained. For example, if white pixels have a value of 1, and black pixels have a value of 0, a pixel having the value of 1 (i.e., white pixel) in FIG. 2A and having the value of 0 (i.e., black pixel) in FIG. 2B has a difference of 1. A pixel having the value of 1 (i.e., a white pixel) in FIGS. 2A and 2B has a difference of 0. A pixel having the value of 0 (i.e., a black pixel) in FIGS. 2A and 2B have a difference of 0. A pixel having the value of 0 (i.e., black pixel) in FIG. 2A and having the value of 1 (i.e., white pixel) in FIG. 2B has a difference of −1.

Referring to FIG. 2C, an edge image is a result of the difference between the information on the image illustrated in FIG. 2A and the information on the moved image illustrated in FIG. 2B. In the edge image, pixels having the value 1 are white, and pixels having the value 0 or −1 are black. Pixels having the value −1 can also be white. As can be appreciated by one skilled in the art, pixels can have a variety of modifications. The image illustrated in FIG. 2C does not contain every edge of the image illustrated in FIG. 2A. However, this is sufficient to extract outline edge information on the image according to an embodiment of the present invention.

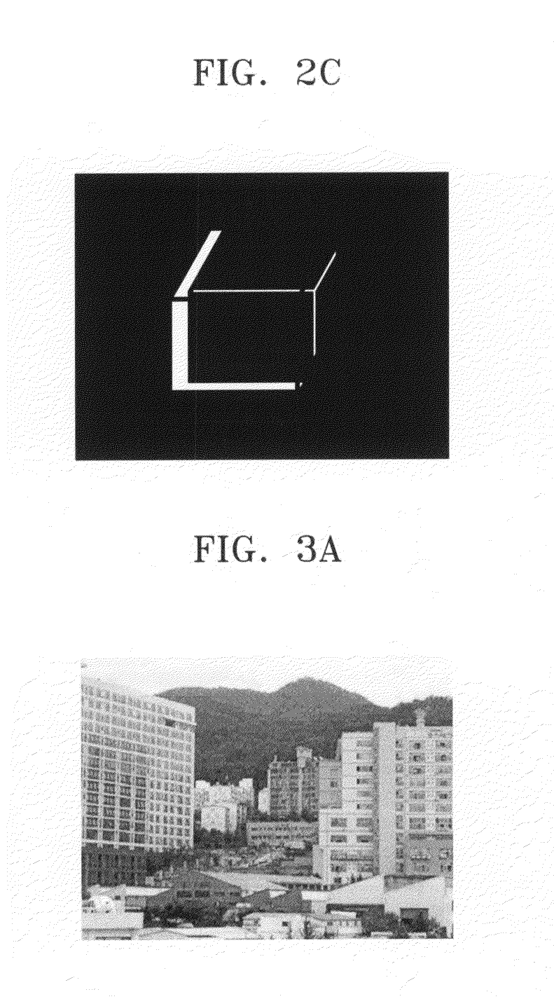

FIGS. 3A and 3B are diagrams of an image before an edge image is extracted from the image, and the edge image extracted from the image, respectively, using a technique according to an embodiment of the present invention. An edge image can be extracted from an image (a frame image) using the technique. The clear edge image illustrated in FIG. 3B can be extracted from the complicated image illustrated in FIG. 3A.

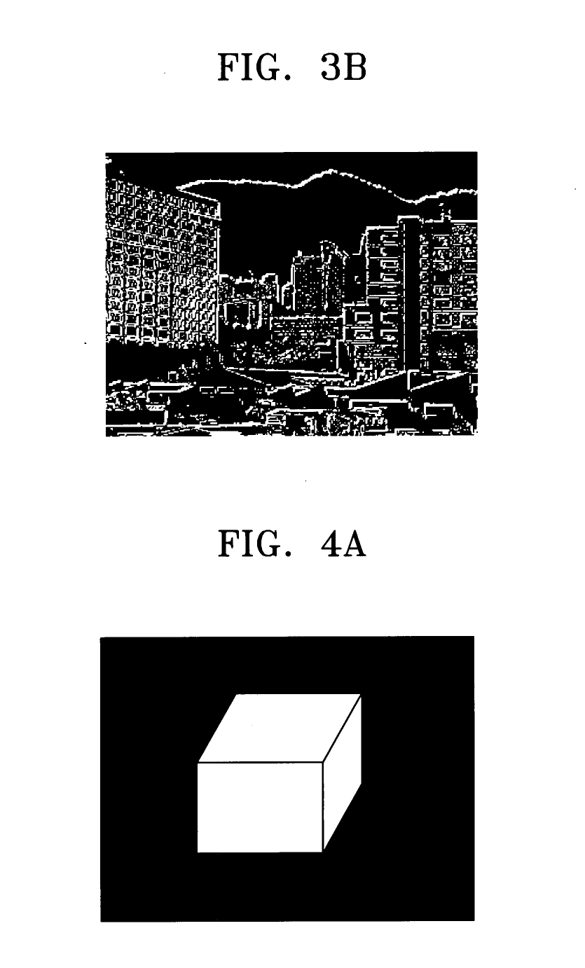

FIGS. 4A through 4D are schematic conceptual diagrams of a process of stabilizing an image using an edge image using a technique according to an embodiment of the present invention. FIG. 4A illustrates a k^{th} image (a k^{th} frame image). FIG. 4B illustrates a k+1^{st} image (a k+1^{st} frame image). Referring to FIGS. 4A and 4B, the position of a box moves in the images since the apparatus for taking the moving picture moves up and down due to shaking.

FIG. 4C illustrates an edge image extracted from the k^{th} image illustrated in FIG. 4A. FIG. 4D illustrates an edge image extracted from the k+1^{st} image illustrated in FIG. 4B. In more detail, FIG. 4C illustrates the edge image of the k^{th} image captured by the apparatus, and FIG. 4D illustrates the edge image of the k+1^{st} image captured by the apparatus. A difference in the position of the edge image of the k^{th} image and the position of the edge image of the k+1^{st} image is calculated. The difference between the position of the edge image of the k^{th} image and that of the k+1^{st} image is identical to a difference in the position of the k^{th} image and the k+1^{st} image. Therefore, the k^{th} image and/or the k+1^{st} image is moved according to the difference in the positions of the edge images and thus a stable image in obtained. If the k+1^{st} image is moved and is stabilized, the edge image of the k^{th} image is identical to an edge image of the moved k+1^{st} image.

Unlike the conventional image stabilizing method, the technique according to an embodiment of the present invention uses the relationship between the position of the edge image of the k^{th} image and the position of the edge image of the k+1^{st} image. When the subject and its background are very simple or the image is very complicated, the edge image is very clear as illustrated in FIG. 3B. Therefore, the relationship between the position of the k^{th} image and the k+1^{st} image can be exactly determined, thereby stabilizing the image.

The edge image of the k^{th} image is obtained by using the k^{th} image and an image obtained when the k^{th} image is moved by a predetermined distance. The edge image of the k+1^{st} image is obtained by using the k+1^{st} image and an image obtained when the k+1^{st} image is moved by a predetermined distance. In this regard, the k^{th} image and the k+1^{st} image can be moved in the same direction as occasion demands since the shape of the edge images can be different according to the direction in which the k^{th} image and the k+1^{st} image are moved.

An image (a frame image) captured by the apparatus is moved by a predetermined distance and an edge image is extracted. The predetermined distance can be freely established. The longer the predetermined distance is, the thicker is the final line of the edge image. However, what is considered is the relationship between the position of the edge image of the k^{th} image and the position of the edge image of the k+1^{st} image, not the thickness of the final line of the edge image. Therefore, the distance that the image is moved can be freely established in order to extract the edge image.

When the k^{th} image is moved by the predetermined distance and the edge image of the k^{th} image is obtained, the k^{th} image can be moved by the predetermined distance up and down, in a diagonal direction, or left and right.

If the apparatus shakes up and down, each image (each frame image) can be moved up and down and stabilized. To obtain exact distance information for the movement of each image up or down, it is preferable that the edge image extracted so as to be used to stabilize the image has a line extending left and right. When the k^{th} image is moved up or down and the edge image of the k^{th} image is obtained, the edge image tends to have the line extending left and right. Therefore, if the apparatus shakes up and down, it is preferable that the k^{th} image is moved up or down in order to extract the edge image of the k^{th} image.

If the apparatus shakes left and right, the k^{th} image may be move left or right and the edge image of the k^{th} image is obtained. If the apparatus shakes in other patterns, the k^{th} image can be moved in a diagonal direction and the edge image of the k^{th} image can be obtained. Therefore, there are a variety of modifications whereby the k^{th} image is moved and the edge image of the k^{th} image is obtained.

The direction in which the k^{th} image is moved by a predetermined distance can be determined according to a direction in which the apparatus for taking the moving picture moves. This direction can be detected by a sensor, such as a gyroscope, attached to the apparatus.

The edge image of the k^{th} image and the edge image of the k+1^{th} image are extracted in order to understand the relationship between the position of the k^{th} image and that of the k+1^{st} image. Therefore, there is no need for color information among information on the k^{th} image and the k+1^{st} image. When the edge images of the k^{th} image and the k+1^{st} image captured by the apparatus for taking the moving picture are extracted, the relationship between the position of the k^{th} image and the k+1^{th} image can be determined by converting the k^{th} image and the k+1^{st} image into black images and extracting edge images of the black k^{th} image and the black k+1^{st} image. When the relationship between the position of the k^{th} image and the k+1^{st} image is used to stabilize the image, the unconverted k^{th} image and/or the unconverted k+1^{st} image is moved and the image is stabilized.

Although an edge image can be extracted using the techniques described above, the edge image can be processed further in order to obtain an edge image that is visibly clearer. For example, the edge image illustrated in FIG. 3B is not obtained from information on the difference in each pixel between the k^{th} image and the image obtained when the k^{th} image is moved by the predetermined distance but is obtained by processing the information on the difference once more.

Since an image has various brightness as illustrated in FIG. 3A, an edge image extracted from the image also can have various levels of brightness. However, since the edge image is extracted in order to understand the relationship between the position of the k^{th} image and the k+1^{st} image, a simpler edge image can be preferable. Therefore, the edge image can have brightness divided into two levels, i.e., black and white with predetermined brightness levels, in order to simplify the edge image.

Information on the difference in each pixel between the k^{th} image and the image obtained when the k^{th} image is moved by a predetermined distance is obtained. If the difference in a pixel is smaller than a predetermined value, the pixel has a value of 0. If the difference in a pixel is greater than the predetermined value, the pixel has a value of 1. A pixel having the value of 0 is a black pixel. A pixel having the value of 1 is a white pixel with a predetermined level of brightness. Therefore, the edge image can be simply and clear as illustrated in FIG. 3B.

The predetermined value used to provide each pixel with a value of 0 or 1 in order to obtain the simplified edge image can be freely established. The smaller the predetermined value is, the more the number of pixels having the value of 1 increases. Accordingly, a white portion increases in the simplified edge image. However, what is considered is the relationship between the position of the edge image of the k^{th} image (the k^{th} frame image) and the position of the edge image of the k+1^{st} image (the k+1^{st} frame image), not the amount of white or black pixels contained in the edge image. Therefore, the predetermined value can be freely established in order to obtain the simplified edge image.

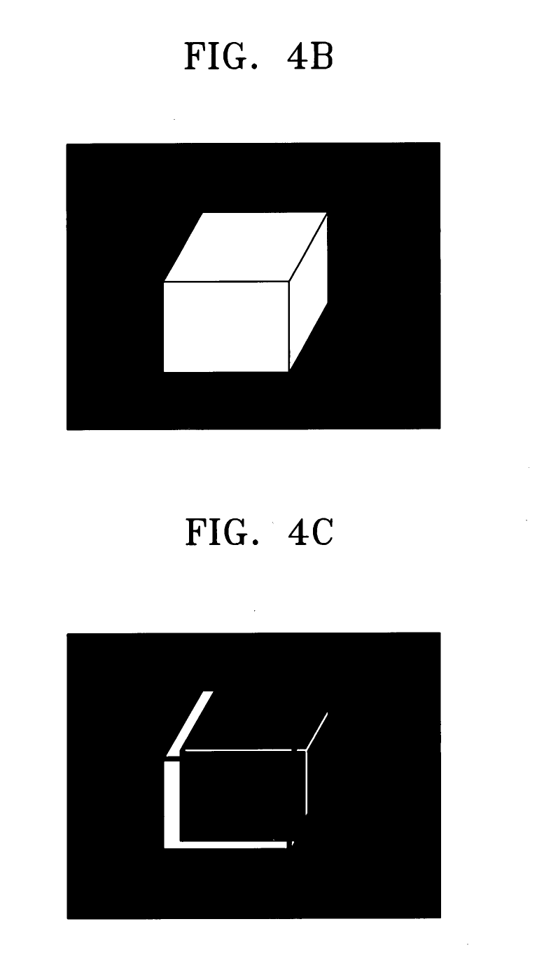

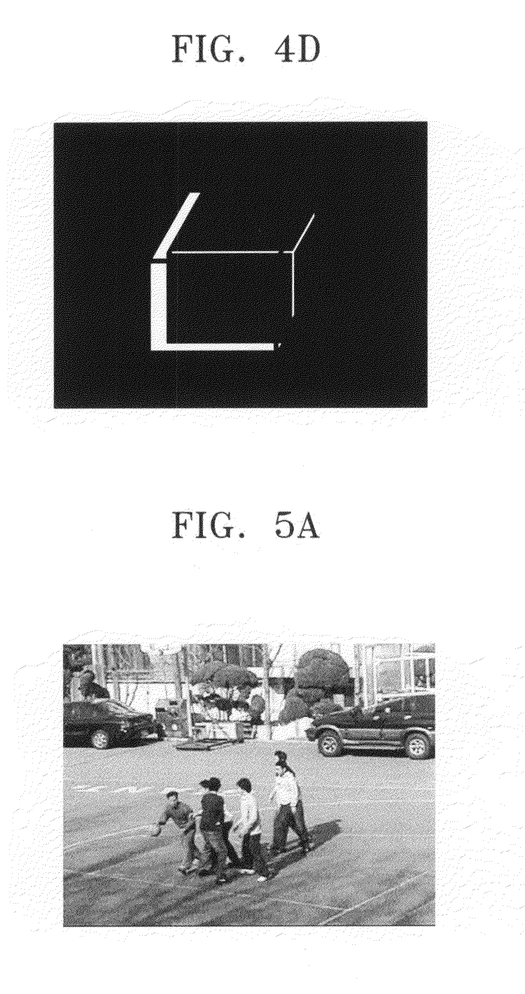

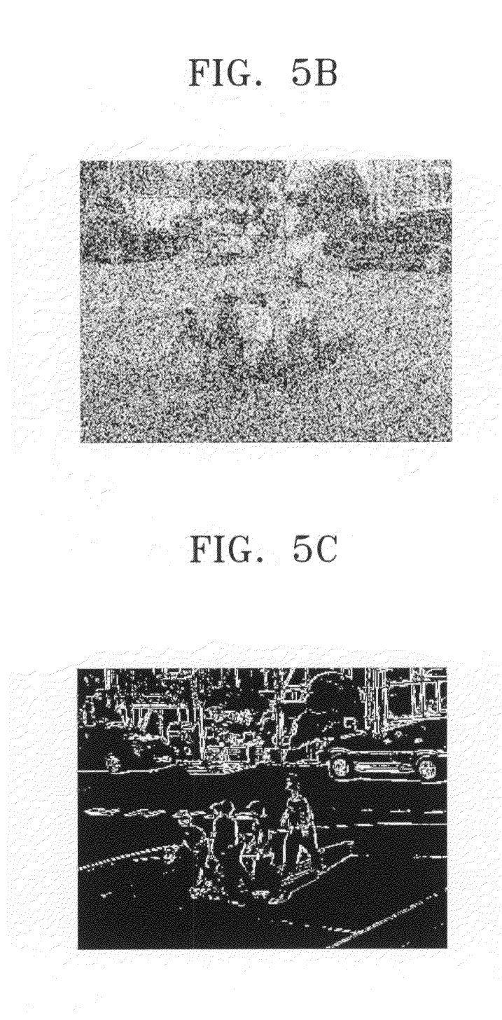

FIG. 5A is a diagram of an image before an edge image is extracted from the image, FIG. 5B is a diagram of an image obtained by adding noise to the image illustrated in FIG. 5A, and FIG. 5C is a diagram of an edge image extracted from the image illustrated in FIG. 5B using the method of controlling the apparatus for taking a moving picture according to an embodiment of the present invention.

As described above, image information includes much noise when moving subject is photographed at night or indoors. However, if an edge image is extracted from the image including the noise illustrated in FIG. 5B using a technique according to an embodiment of the present invention, a very simple and relatively clear edge image can be obtained as illustrated in FIG. 5C. Since the noise included in the image illustrated in FIG. 5B randomly spreads, the noise disappears while the edge image is extracted. Therefore, the edge image can be used to easily determine a relative position (distance and direction) between the k^{th} image and the k+1^{th} image so that the image can be stabilized by adjusting the relative position between the k^{th} image and the k+1^{st} image.

Table 1 shows root mean square errors (RMSEs) of the stability of an image using two conventional image stabilization methods, which are the result of seven tests, and RMSEs of the stability of the image using an image stabilization method and apparatus for taking the moving picture according to an embodiment of the present invention, which are also the result of seven tests. In Table 1, the RMSE of the stability of the image is 0 if the k^{th} image and the k+1^{st} image are exactly stabilized and the reproduced moving picture does not shake. When the k+1^{th} image is not completely moved to exactly correspond to the k^{th} image, the RMSE is a RMSE of a distance between the completely moved k+1^{th} image and the incompletely moved k+1^{th} image. Therefore, the smaller the RMSE of the stability of the image is, the less the reproduced moving picture shakes.

TABLE 1

| | test 1 | test 2 | test 3 | test 4 | test 5 | test 6 | test 7 |
|---|---|---|---|---|---|---|---|
| Conventional | 0.137 | 0.142 | 0.114 | 0.102 | 0.161 | 0.108 | 0.112 |
| method 1 | | | | | | | |
| Conventional | 0.139 | 0.183 | 0.142 | 0.139 | 0.194 | 0.132 | 0.146 |
| method 2 | | | | | | | |
| Method according to | 0.123 | 0.121 | 0.102 | 0.092 | 0.116 | 0.111 | 0.091 |
| an embodiment of the | | | | | | | |
| present invention | | | | | | | |

In Table 1, the conventional method 1 uses a technique referred to as “assignment of the weighted average of all local motion vectors weighted by their peak amplitude values” as described in a publication by S. Erturk entitled “Digital Image Stabilization with Sub-Image Phase Correlation Based Global Motion Estimation,” in IEEE Trans. Consumer Electronics, vol. 49, no. 4, pp. 1320-1325, November 2003, and the conventional method 2 uses 1 BTM (1 bit transform matching) as described in a publication by A. Yeni, et al. entitled “Fast digital image stabilization using one bit transform based sub-image motion estimation,” in IEEE Trans. Consumer Electronics, vol. 49, no. 4, pp. 1320-1325, November 2003.

As indicated in Table 1, the image is considerably stabilized using the method of controlling the apparatus for taking the moving picture according to the present embodiment compared to the conventional methods 1 and 2.

Table 2 below shows root mean square (RMS) error values of the stability of an image using two conventional image stabilization methods, which are the result of seven tests, and RMS error values of the stability of the image using an image stabilization method an apparatus for taking the moving picture according to an embodiment of the present invention, i.e., the image stabilization method, which are also the result of seven tests. The image is obtained by adding noise to the image used in Table 1.

TABLE 2

| | test 1 | test 2 | Test 3 | test 4 | test 5 | test 6 | test 7 |
|---|---|---|---|---|---|---|---|
| Conventional | 0.431 | 0.598 | 0.422 | 0.487 | 0.453 | 0.455 | 0.561 |
| method 1 | | | | | | | |
| Conventional | 0.311 | 0.772 | 0.389 | 0.566 | 0.823 | 0.588 | 0.427 |
| method 2 | | | | | | | |
| Method | 0.128 | 0.132 | 0.111 | 0.0098 | 0.135 | 0.113 | 0.094 |
| according to | | | | | | | |
| embodiment of | | | | | | | |
| the invention | | | | | | | |

As indicated in Table 2, the image including noise is considerably stabilized using the method and apparatus according to an embodiment of the present invention as compared to the conventional methods 1 and 2.

The method of controlling an apparatus for taking a moving picture according to the present invention and the apparatus for taking the moving picture adopting the method can effectively stabilize an image and thereby reduce the effect of shaking of the apparatus for taking the moving picture.

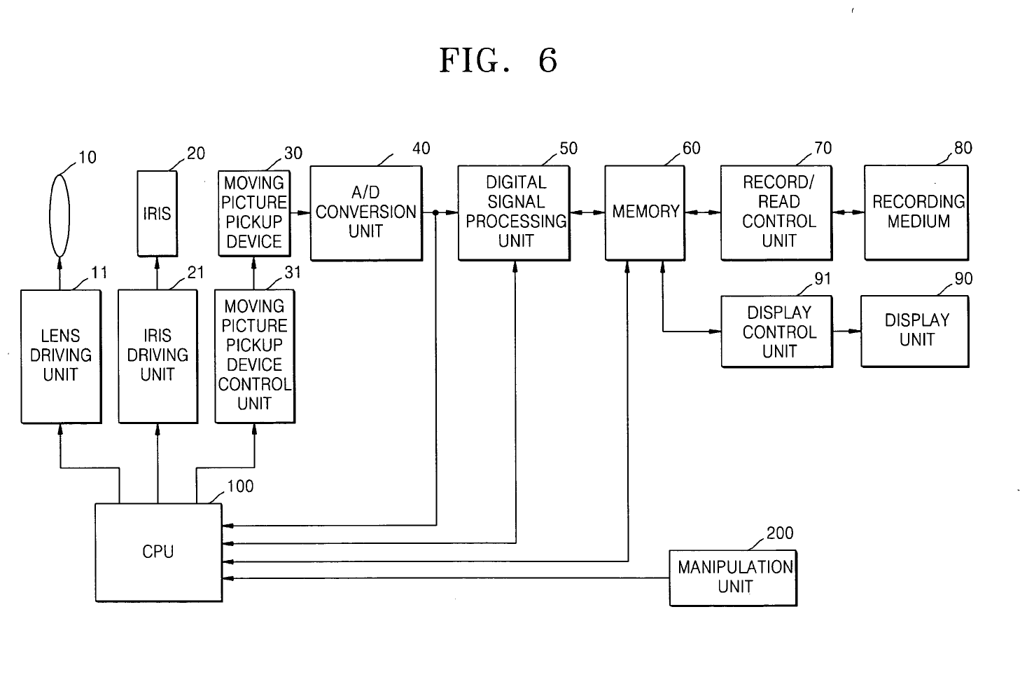

FIG. 6 is a block diagram illustrating an apparatus for taking a moving picture according to an embodiment of the present invention.

The entire operation of the apparatus is controlled by a CPU 100. A manipulation unit 200, including a key generating an electrical signal from a user, is included in the apparatus. An electrical signal from the manipulation unit 200 is transferred to the CPU 100 such that the CPU 100 can control the apparatus according to the electrical signal.

In a moving picture taking mode, if an electrical signal from the user is transferred to the CPU 100, the CPU 100 identifies the signal and controls a lens driving unit 11, an iris driving unit 21, and a moving picture pickup device control unit 31. According to this control, the position of a lens 10, opening of the iris 20, and sensitivity of a moving picture pickup device 30 are controlled for autofocusing. If a data signal of a moving picture is output from the moving picture pickup device 30, the signal is converted into digital moving picture data by an analog-to-digital (A/D) conversion unit 40, and input to the CPU 100 and a digital signal processing unit 50. The digital signal processing unit 50 performs digital signal processing, such as gamma correction and white balance adjustment.

The moving picture data output from the digital signal processing unit 50 is transferred through a memory 60 or directly to a display control unit 91. Here, the memory 60 includes a read-only memory (ROM) or a random-access memory (RAM). The display control unit 91 controls a display unit 90 and displays a moving picture on the display unit 90. The moving picture data output from the digital signal processing unit 50 can be input to a recording/reading control unit 70 through the memory 60. The recording/reading control unit 70 records the moving picture data on a recording medium 80 automatically or according to a command from the user. Also, the recording/reading control unit 70 can read moving picture data of a moving picture file stored in the recording medium 80, and input the read moving picture data to the display control unit 91 so that the moving picture can be displayed on the display unit 90.

A program for executing the control method of the apparatus for taking a moving picture according to the embodiments and variations of present invention can be stored in a recording medium.

The recording medium storing the control method of the apparatus may be the recording medium 80 or the memory 60 as illustrated in FIG. 6, or may also be a separate recording medium. Examples of the recording medium include magnetic storage medium (for example, read-only memory (ROM), and hard disks) and optical data storage devices (for example, CD-ROM, digital versatile disc (DVD)). Also, the CPU 100 illustrated in FIG. 6 or part of the CPU 100 may be employed as the recording medium.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of controlling an apparatus for taking a moving picture, the method comprising:
extracting an edge image of a k^{th} image that is input into the apparatus for taking the moving picture;
extracting an edge image of a k+1^{st} image that is input into the apparatus for taking the moving picture;
calculating a difference in the position of the edge image of the k^{th} image and the position of the edge image of the k+1^{st} image; and
stabilizing an image by moving at least one of the k^{th} image and the k+1^{st} image according to the difference in the position.

2. The method of claim 1, wherein
the extracting of the edge image of the k^{th} image comprises:
obtaining an image by moving the k^{th} image by a predetermined distance; and
calculating a difference in each pixel between the k^{th} image and the image obtained when the k^{th} image is moved; and
the extracting of the edge image of the k+1^{st} image comprises:
obtaining an image by moving the k+1^{st} image by a predetermined distance; and
calculating a difference in each pixel between the k+1^{st} image and the image obtained when the k+1^{st} image is moved.

3. The method of claim 2, wherein the obtaining of the image by moving the k^{th} image by the predetermined distance and the obtaining of the image by moving the k+1^{st} image by the predetermined distance comprise moving the k^{th} image and the k+1^{st} image in the same direction.

4. The method of claim 2, wherein
the obtaining of the image by moving the k^{th} image by the predetermined distance comprises moving the k^{th} image by the predetermined distance up or down; and
the obtaining of the image by moving the k+1^{st} image by the predetermined distance comprises moving the k+1^{st} image by the predetermined distance up or down.

5. The method of claim 2, wherein
the obtaining of the image by moving the k^{th} image by the predetermined distance comprises moving the k^{th} image by the predetermined distance in a diagonal direction; and
the obtaining of the image by moving the k+1^{st} image by the predetermined distance comprises moving the k+1^{st} image by the predetermined distance in the diagonal direction.

6. The method of claim 2, wherein
the obtaining of the image by moving the k^{th} image by the predetermined distance comprises moving the k^{th} image by the predetermined distance left or right; and
the obtaining of the image by moving the k+1^{st} image by the predetermined distance comprises moving the k+1^{st} image by the predetermined distance left or right.

7. The method of claim 1, wherein
the extracting of the edge image of the k^{th} image further comprises:
if the difference of each pixel is smaller than a predetermined value, providing pixels with a value of 0, and, if the difference of each pixel is greater than the predetermined value, providing pixels with a value of 1; and
the extracting of the edge image of the k+1^{st} image further comprises:
if the difference of each pixel is smaller than the predetermined value, providing pixels with the value of 0, and, if the difference of each pixel is greater than the predetermined value, providing pixels with the value of 1.

8. The method of claim 1, wherein
the extracting of the edge image of the k^{th} image that is input into the apparatus for taking the moving picture comprises converting the k^{th} image into a black image and extracting an edge image of the converted k^{th} image; and
the extracting of the edge image of the k+1^{st} image that is input into the apparatus for taking the moving picture comprises converting the k+1^{st} image into a black image and extracting an edge image of the converted k+1^{st} image.

9. The method of claim 8, wherein the stabilizing of the image comprises
moving at least one of an unconverted k^{th} image and an unconverted k+1^{st} image in accordance with the difference in the position.

10. The method of claim 1, wherein the stabilizing of the image further comprises moving the k+1^{th} image in an opposite direction by an amount equal to the difference in the position, and making the edge image of the k^{th} image correspond to the edge image of the moved k+1^{th} image.

11. A computer readable medium of instructions for controlling an apparatus for taking a moving picture, the computer readable medium of instructions comprising:
a first set of instructions operating to extract an edge image of a k^{th} image that is input into the apparatus for taking the moving picture;
a second set of instructions operating to extract an edge image of a k+1^{st} image that is input into the apparatus for taking the moving picture;
a third set of instructions operating to calculate a difference in the position of the edge image of the k^{th} image and the position of the edge image of the k+1^{st} image; and
a fourth set of instructions operating to stabilize an image by moving at least one of the k^{th} image and the k+1^{st} image according to the difference in the position.

12. The computer readable medium of instructions of claim 11, wherein
the first set of instructions operates to extract the edge image of the k^{th} image by obtaining an image by moving the k^{th} image by a predetermined distance and calculating a difference in each pixel between the k^{th} image and the image obtained when the k^{th} image is moved; and
the second set of instructions operates to extract the edge image of the k+1^{st} image by obtaining an image by moving the k+1^{st} image by a predetermined distance and calculating a difference in each pixel between the k+1^{st} image and the image obtained when the k+1^{st} image is moved.

13. The computer readable medium of instructions of claim 12, wherein
the first and second sets of instructions perform the moving of the k^{th} image and the k+1^{st} image, respectively, by moving the k^{th} image and the k+1^{st} image in the same direction.

14. The computer readable medium of instructions of claim 12, wherein
the first set of instructions performs the moving of the k^{th} image by moving the k^{th} image by the predetermined distance up or down; and
the second set of instructions performs the moving of the k+1^{st} image by moving the k+1^{st} image by the predetermined distance up or down.

15. The computer readable medium of instructions of claim 12, wherein
the first set of instructions performs the moving of the k^{th} image by moving the k^{th} image by the predetermined distance in a diagonal direction; and
the second set of instructions performs the moving of the k+1^{st} image by moving the k+1^{st} image by the predetermined distance in the diagonal direction.

16. The computer readable medium of instructions of claim 12, wherein
the first set of instructions performs the moving of the k^{th} image by moving the k^{th} image by the predetermined distance left or right; and
the second set of instructions performs the moving of the k+1^{st} image by moving the k+1^{st} image by the predetermined distance left or right.

17. The computer readable medium of instructions of claim 12, wherein
the first set of instructions extracts the edge image of the k^{th} image, such that if the difference of each pixel is smaller than a predetermined value, the first set of instructions operates to provide pixels with a value of 0, and, if the difference of each pixel is greater than the predetermined value, the first set of instructions operates to provide pixels with a value of 1; and
the second set of instructions extracts the edge image of the k+1^{st} image, such that if the difference of each pixel is smaller than the predetermined value, the second set of instructions operates to provide pixels with the value of 0, and, if the difference of each pixel is greater than the predetermined value, the second set of instructions operates to provide pixels with the value of 1.

18. The computer readable medium of instructions of claim 11, wherein
the first set of instructions extracts the edge image of the k^{th} image that is input into the apparatus for taking the moving picture by converting the k^{th} image into a black image and extracting an edge image of the converted k^{th} image; and
the second set of instructions that extracts the edge image of the k+1^{st} image that is input into the apparatus for taking the moving picture by converting the k+1^{st} image into a black image and extracting an edge image of the converted k+1^{st} image.

19. The computer readable medium of instructions of claim 18, wherein
the fourth set of instructions stabilizes the image by moving at least one of an unconverted k^{th} image and an unconverted k+1^{st} image in accordance with the difference in the position.

20. The computer readable medium of instructions of claim 11, wherein the fourth set of instructions stabilizes the image by moving the k+1^{th} image in an opposite direction by an amount equal to the difference between the positions, and making the edge image of the k^{th} image correspond to the edge image of the moved k+1^{th} image.
